(19) United States
(12) Patent Application Publication
(10) Pub. No.: US 2018/0154488 A1
(43) Pub. Date: Jun. 7, 2018

(54) Device And Method For Positioning Connection Elements

(71) Applicant: Arnold Umformtechnik GmbH & Co. KG, Forchtenberg-Ernsbach (DE)

(72) Inventors: Uwe WOLFARTH, Schrozberg (DE); Joachim LUTZ, Talheim (DE); Alex LINDT, Künzelsau (DE)

(21) Appl. No.: 15/578,425

(22) PCT Filed: May 27, 2016
(86) PCT No.: PCT/EP2016/061985

§ 371 Date: Nov. 30, 2017

(30) Foreign Application Priority Data
Jun. 3, 2015 (DE) 10 2015 210 322.6

(51) Int. Cl. B23P 19/06; B23P 19/00

(52) U.S. Cl. CPC B23P 19/062; B21J 15/32; B23P 19/007; B23P 19/006

(57) ABSTRACT

The invention relates to an apparatus comprising an advancing device and a blocking device (4), having a lever (40) that is adjustable between a blocking position and a releasing position, and to a method for positioning connecting elements, wherein a connecting element (2) is transferable by means of the advancing device (3) from a receiving region (I) into a delivery region (II) for a joining device, wherein the at least one lever (40) prevents any movement of the connecting element (2) from the receiving region (I) into the delivery region (II) in the blocking position and enables same in the releasing position, and wherein, by means of an end stop, any movement of the lever (40) from the blocking position into the releasing position is preventable. The at least one lever (40) is designed as a two-sided lever (40) having a first arm (41) and a second arm (42), wherein a first arm (41) of the at least one lever (40) interacts with the at least one end stop in order to prevent any movement of the at least one lever (40) from the blocking position into the releasing position, and a second arm (42) of the at least one lever (40) acts, in the blocking position, as a retaining jaw for the connecting element (2). The invention also relates to an apparatus for setting connecting elements.

### FIELD OF APPLICATION AND PRIOR ART

The invention relates to an apparatus and to a method for positioning connecting elements, wherein a connecting element is transferable by means of an advancing device from a receiving region into a delivery region for a joining device, and wherein a blocking device prevents any movement of the connecting element from the receiving region into the delivery region in the blocking position. The invention also relates to an apparatus for setting connecting elements.

The connecting element is for example a press-in bolt or a joining element known for example from DE 10 2004 025 492 A1. These connecting elements have a head and a shank, wherein the shank has a thread in one configuration and a cutting point in other configurations. Alternatively or additionally, a circumferential depression is formed beneath the head, said depression serving for the axially fixed connection of the connecting element to a component or assembly into which the connecting element is pressed.

A method and an apparatus for pressing in press-in bolts is known for example from DE 10 2006 016 255 A1.

### Problem and Solution

The invention is based on the problem of creating a possibility of positioning connecting elements with a high degree of accuracy at a given time for a joining device, for example a setting die.

According to a first aspect, an apparatus for positioning connecting elements, having an advancing device and a blocking device, which has at least one lever that is pivotable between a blocking position and a releasing position, is created, wherein a connecting element is transferable by means of the advancing device from a receiving region into a delivery region for a joining device, wherein the at least one lever is pivotable between a blocking position and a releasing position, wherein the at least one lever prevents any movement of the connecting element from the receiving region into the delivery region in the blocking position, wherein at least one end stop that is adjustable relative to the at least one lever is provided, by means of which end stop a movement of the at least one lever from the blocking position into the releasing position is preventable, wherein the at least one lever is designed as a two-sided lever having a first arm and a second arm, and wherein a first arm of the at least one lever interacts with the at least one end stop to prevent any movement of the at least one lever from the blocking position into the releasing position, and a second arm of the at least one lever acts, in the blocking position, as a retaining jaw for the connecting element.

The connecting element is conveyed into the receiving region for example by means of compressed air. The end stop prevents a connecting element entering the receiving region at high speed and/or with high kinetic energy from acting on the blocking device such that the latter is transferred early and/or in an uncontrolled manner into the releasing position. The end stop thus prevents an uncontrolled and/or early movement of the connecting element from the receiving region into the delivery region. The connecting element is transferred into the delivery region for a joining device, for example for a setting die, by means of the advancing device, wherein this movement is allowed only after or together with moving of the end stop.

If only one lever is provided, the apparatus preferably has a suitable counterface with which the blocking device and/or the end stop interact. In order to secure the blocking device in the blocking position, the end stop is positioned, in a configuration with only one lever, on an inner side of the first arm of the lever. As a result, a pivoting movement of the lever, during which a second arm is pivoted outward, is prevented and the connecting element is clampable between the second arm of the lever and a counterface.

In one configuration, the blocking device has two two-sided levers that are pivotable in opposite directions, wherein the first arms of the levers interact with the end stop to prevent any movement of the levers from the blocking position into the releasing position, and the second arms of the levers act as retaining jaws for the connecting element. The levers are preferably arranged symmetrically to a centerline. In order to secure the blocking device in the blocking position, the end stop is pushed between the two first arms of the levers, such that a pivoting movement of the levers, as a result of which the two first arms move toward one another, is prevented. In this way, the connecting element is securely clampable between the two second arms of the levers.

In one configuration, the at least one lever is assigned a force element, in particular a spring element, which forces the lever into the blocking position. Since the force element acts on the at least one lever only in a supporting manner, it is possible to design a spring force to be less than for example in an apparatus known from DE 10 2006 016 255 A1. In some configurations, the force element is dispensed with.

In one configuration, a guide device, for example a guide rail, is provided, along which the connecting elements are displaced from the receiving region into the delivery region. In advantageous configurations, the connecting element is displaceable into the delivery region along the second arm of the one lever or along the second arms of the two levers by means of the advancing device. To this end, the second arm of the lever or the second arms of the levers preferably have a guide face, wherein, for example in the case of a connecting element having a shank and a head, an underside of the head rests on the guide face and the shank is guided between the levers—or between one lever and a guide rail—in the releasing position of the lever and is clamped in the blocking position.

The advancing device preferably comprises a slider that is displaceable linearly relative to the at least one lever. The slider engages, for example in the case of a connecting element having a shank and a head, with the shank for an adjusting movement of the connecting element. A shape of a free end of the slider is in this case matched to the shape of the connecting element in advantageous configurations. In one configuration, the end stop is designed to be separate from the slider, wherein a movement of the end stop and a movement of the slider are matched to one another, so as to ensure that the blocking device is released from the blocking position during an adjusting movement of the connecting element by means of the slider. In this case, the end stop is moved for example in the opposite direction to the slider from the region between the levers or between one lever and a counterface. In advantageous configurations, a first portion of the slider acts as an end stop. As a result, it is possible to dispense with additional drive means, transmission elements or the like.

Preferably, the slider has a second portion that is spaced apart from the first portion in a longitudinal direction, wherein the second portion has a design such as to enable the lever to pivot into the releasing position after an unlocking position has been crossed. In other words, for example a cross section of a slider introduced between two levers is not constant. The slider is adjustable relative to the blocking device. In a first position, a first portion that acts as an end stop is introduced between the first arms of the levers, such that the levers are prevented from pivoting into the releasing position. Upon displacement of the slider, after an unlocking position has been crossed, the second portion passes between the two first arms. The second portion is designed such that a pivoting movement of the levers into the releasing position is possible. In one configuration, to this end, a cross section of the slider in the plane of the levers is tapered in the second portion compared with the first portion.

In advantageous configurations, the first arm of the lever or levers has a protrusion that projects into the adjustment travel of the slider and interacts with the end stop, wherein, preferably, a wall, facing the protrusion, of the slider has a groove in the second portion. As a result, a pivoting movement of the levers into the releasing position is possible, wherein, at the same time, wall regions of the slider that adjoin the groove remain as guide faces for the slider.

In advantageous configurations, provision is made for a maximum adjusting movement of the advancing device in the direction of the delivery region to be greater during an idle stroke than during a positioning stroke of a connecting element. In other words, an adjusting movement is limited by the connecting element, whereas, during an idle stroke, i.e. a movement without a connecting element being inserted, the advancing device, in particular the slider, is moved over this end position. The movement of the slider is able to be sensed by means of sensors. This makes it possible to easily check for the presence of a connecting element in the transfer region, wherein, only when a connecting element is present there does activation of the joining device take place, for example a setting operation is triggered.

According to a second aspect, an apparatus for setting connecting elements, having a feed device for feeding connecting elements individually to a receiving region; having a setting die for setting a connecting element positioned in a delivery region, and having an apparatus for positioning connecting elements, is created, wherein the apparatus for positioning connecting elements has an advancing device, by means of which a connecting element is transferable from the receiving region into the delivery region, a blocking device having at least one lever that is adjustable between a blocking position and a releasing position, and an end stop that is adjustable relative to the lever, wherein the lever prevents any movement of the connecting element out of the receiving region in the blocking position, and wherein, by means of the end stop, any movement of the lever from the blocking position into the releasing position is preventable. The connecting element is pressed or inserted into a component or an assembly for example by means of the apparatus. In one configuration, the setting die has, at its free end, a device by means of which the connecting element is retained on the setting die. To this end, for example a magnet and/or a suction apparatus, which holds on to the connecting element with the aid of negative pressure, is provided. In advantageous configurations, mechanical clamps for retaining the connecting elements are provided on the setting die. The feed device is preferably designed as a blowing device comprising at least one channel section, wherein the connecting element is blown through the channel section by air pressure. The channel section adjoining the apparatus for positioning connecting elements is preferably curved, wherein an end region opens tangentially into the receiving region.

According to a third aspect, in a method for positioning connecting elements, wherein a connecting element is transferred by means of an advancing device from a receiving region into a delivery region for a joining device, a movement of the connecting element from the receiving region into the delivery region is prevented by means of at least one lever, arranged in a blocking position, of a blocking device, the at least one lever is transferred into a releasing position in order for the connecting element to move into the delivery region, it is provided that, when the connecting element is received in the receiving region, any movement of the at least one lever from the blocking position into the releasing position is prevented by means of an end stop, wherein the at least one lever is designed as a two-sided lever having a first arm and a second arm, wherein a first arm of the at least one lever interacts with the end stop when the connecting element is received in the receiving region, such that any movement of the lever from the blocking position into the releasing position is prevented, and wherein the movement of the connecting element from the receiving region into the delivery region is prevented by means of a second arm of the at least one two-sided lever, arranged in the blocking position, of the blocking device.

### BRIEF DESCRIPTION OF THE DRAWINGS

Further features, details and advantages of the invention can be gathered from the claims and the abstract, the wording of both of which is made part of the contents of the description by reference, from the following description of preferred embodiments of the invention and by way of the drawing. Features that are illustrated or described as part of an exemplary embodiment can also be used in another exemplary embodiment in order to obtain a further embodiment of the invention. In the drawing:

FIG. 1 schematically shows a perspective illustration of an apparatus for positioning connecting elements;

FIG. 2 shows a cross-sectional plan view of the apparatus according to FIG. 1 before a connecting element is received;

FIG. 3 shows a cross-sectional plan view of the apparatus according to FIG. 1 when a connecting element is received in the receiving region;

FIG. 4 shows a cross-sectional plan view of the apparatus according to FIG. 1 at the start of the transfer of the connecting element from the receiving region into the delivery region;

FIG. 5 shows a cross-sectional plan view of the apparatus according to FIG. 1 during the transfer of the connecting element from the receiving region into the delivery region;

FIG. 6 shows a cross-sectional plan view of the apparatus according to FIG. 1 after the connecting element has been transferred into the delivery region;

FIG. 7 schematically shows a cross-sectional, perspective side view of an apparatus for setting connecting elements; and

FIG. 8 shows a cross-sectional plan view of a second embodiment of an apparatus for positioning connecting elements in a state according to FIG. 3.

### DETAILED DESCRIPTION OF THE EXEMPLARY EMBODIMENTS

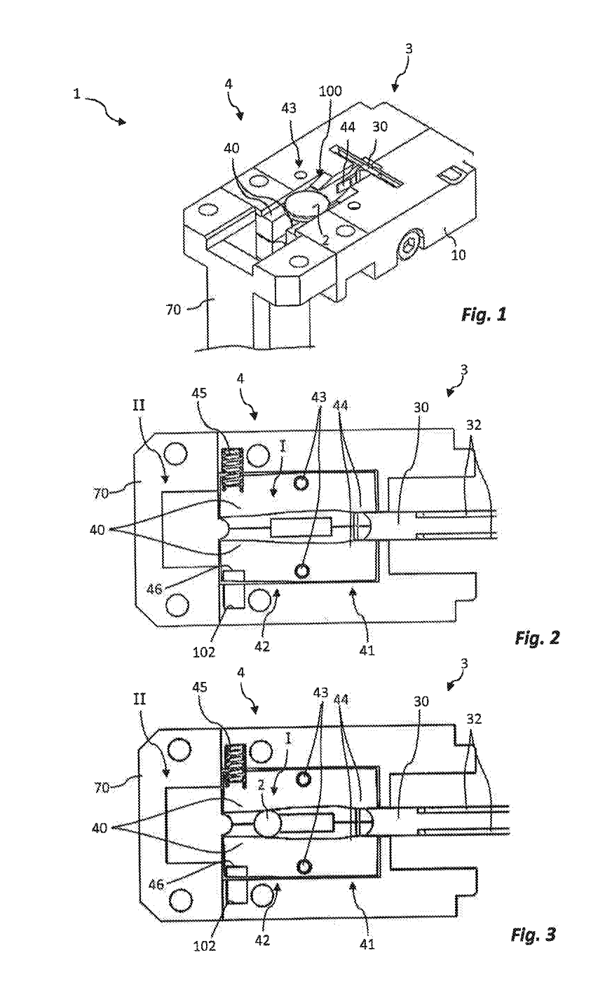

FIG. 1 schematically shows a perspective illustration of an apparatus 1 for positioning connecting elements 2 in a delivery region for a joining or setting device (not shown in FIG. 1). FIGS. 2 to 6 show the apparatus 1 according to FIG. 1 in a cross-sectional plan view before a connecting element 2 is received, during the receiving of a connecting element 2 in a receiving region I, at the start of the transfer of the connecting element 2 from the receiving region I into the delivery region II, during the transfer of the connecting element 2 from the receiving region I into the delivery region II, and after the connecting element 2 has been transferred into the delivery region II, respectively.

The connecting element 2 is in the form of a bolt with a head and a shank.

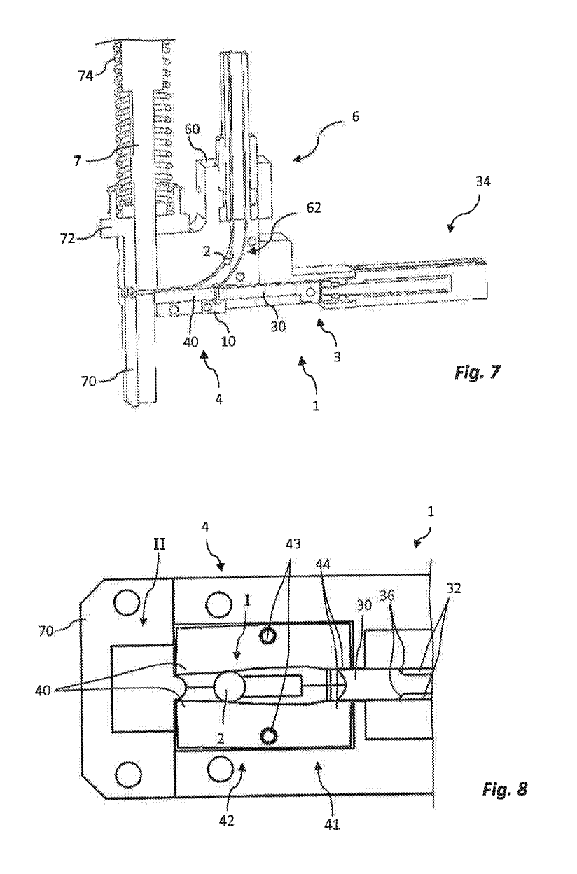

The apparatus 1 comprises an advancing device 3 and a blocking device 4. The illustrated apparatus 1 furthermore comprises a bearing plate 10, with the aid of which the apparatus 1 can be mounted on an installation (not illustrated). The bearing plate 10 has a guide slope 100 such that a connecting element 2 fed by a feed device 6 (cf. FIG. 7) is guided into an end, facing the delivery region II, of the receiving region I. In the delivery region II, the connecting element 2 is accessible to a setting die 7 (cf. FIG. 7) or some other joining device, wherein, in the exemplary embodiment illustrated, the delivery region II is bounded by a guide rail 70.

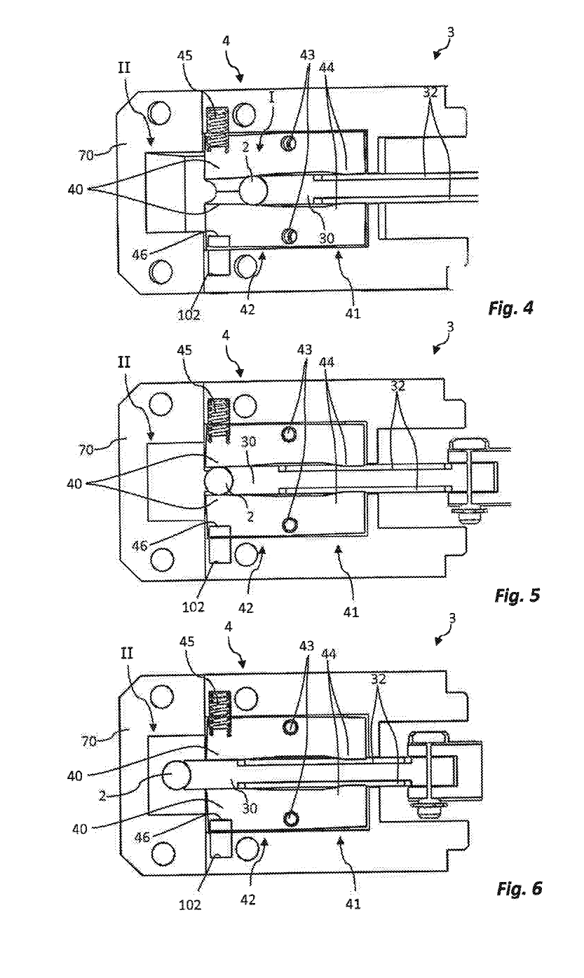

A connecting element 2 is transferable by means of the advancing device 3 from the receiving region into the delivery region II. The illustrated advancing device 3 comprises an adjustable slider 30 which acts on a shank of the connecting element 2 in order to displace the connecting element 2, as illustrated in FIGS. 4 to 6. The slider 30 has, on each of its side faces, a groove 32 that extends in a longitudinal direction. In one configuration, the slider 30 is adjustable by means of a pneumatic cylinder 34 (cf. FIG. 7). Instead of a pneumatic cylinder, alternative drives, for example by means of hydraulic and/or electric are conceivable. Depending on the requirement, the pneumatic cylinder is designed to be single-acting or double-acting. To give a better view, the pneumatic cylinder 30 of the advancing device 3 is not illustrated in FIGS. 1 to 6.

By means of the blocking device 4, any movement of a connecting element 2 from the receiving region into the delivery region II is preventable. To this end, the blocking device 4 has at least one lever 40, wherein any movement of the connecting element from the receiving region I into the delivery region II is prevented by means of the lever 40 arranged in a blocking position, and wherein the lever 40 is transferred into a releasing position in order for the connecting element to move into the delivery region.

In the exemplary embodiment illustrated, the blocking device 4 comprises two two-sided levers 40 that are pivotable in opposite directions. The levers 40 each have a first arm 41 and a second arm 42 and are pivotable between a blocking position and a releasing position about an axis located between the first and the second arm by means of pins 43. On the first arms 41, the levers 40 each have a protrusion 44, the function of which is described further below. A spring element 45 acts on each of the levers 40, said spring element 45 forcing the levers 40 into the blocking position, wherein only one spring element 45 is illustrated in FIGS. 2 to 6. The spring element 45 is inserted into corresponding recesses 46, 102 in the lever 40 and the bearing plate 100, respectively.

The illustrated levers 40 have a dual function, since, additionally, a face facing the head of the connecting element 2 also serves as a guide face for the connecting elements 2 during the movement from the receiving region I into the delivery region II by means of the slider 30. The shank of the connecting elements is arranged between the levers 40. In other configurations, the connecting element 2 is pushed along a guide rail arranged separately from the levers 40.

As can be seen in FIG. 3, the levers 40 prevent any movement of the connecting element 2 from the receiving region I in the direction of the delivery region II in the blocking position. To this end, a spacing of the second arms 42 of the levers 40 is at least regionally less than a diameter of the shank of the connecting elements 2. In the exemplary embodiment illustrated, the second arms 42 each have a run-in slope on their faces facing the shank of the connecting element 2.

The levers 40 are pivotable from the blocking position illustrated in FIGS. 1 to 3 into a releasing position illustrated in FIG. 5, in which a spacing of the second arms 42 is greater than a shank diameter and it is possible for the connecting element 2 to move in the direction of the delivery region II.

According to the invention, by means of an end stop, any movement of the levers 40 from the blocking position into the releasing position is preventable, wherein, in the exemplary embodiment illustrated, a first portion of the slider 30 acts as an end stop.

In the state illustrated in FIGS. 1 to 3, the first portion of the slider 30 has been introduced between the first arms 41 of the levers 40. The first portion, acting as an end stop, of the slider 30 thus prevents any pivoting movement of the levers 40 out of the blocking position illustrated in FIGS. 1 to 3.

In the exemplary embodiment illustrated, the levers 40 each have a protrusion 44 which projects into the adjustment travel of the slider 30 and interacts with a side wall of the slider 30 in order to secure the levers 40 in the blocking position.

In order to transfer the connecting element 2 into the delivery region II, the slider 30 is driven such that the slider 30 is moved toward the connecting element 2. The slider 30 is displaced relative to the levers 40. As can be seen in FIG. 4, a second portion of the slider 30, which has the grooves 32, passes into the region of the protrusions 44 in the process. The grooves 32 allow a pivoting movement of the levers 40 from the blocking position into the releasing position, wherein the protrusions 44 are introduced into the grooves 32.

As can be seen in FIG. 4, the spring elements 45 first of all force the levers 40 into the blocking position, such that, although a movement of the levers 40 is no longer blocked, the levers 40 initially remain in the blocking position and continue to prevent the movement of the connecting elements 2 from the receiving region I into the delivery region II. As soon as the slider 30 acts on the connecting element 2, to be more precise on the shank thereof, the connecting element 2 is displaced in the direction of the delivery region II, wherein the levers 40 are forced into the releasing position counter to the force of the spring elements 45, as can be seen in FIG. 5.

When the slider 30 is pulled back from the position illustrated in FIG. 6 into the position illustrated in FIG. 2, the spring elements 45 force the levers 40 into the blocking position, such that tilting of the protrusions 44 in the grooves 32 is prevented.

FIG. 7 shows the apparatus for setting connecting elements 2, having a feed device 6 for feeding connecting elements 2 individually to a receiving region I (cf. FIGS. 2 to 6), having a setting die 7 for setting a connecting element 2 positioned in a delivery region II (cf. FIGS. 2 to 6), and an apparatus 1 according to FIGS. 1 to 6 comprising an advancing device 3 and a blocking device 4, wherein, by means of the apparatus 1, a connecting element 2 is transferable from the receiving region I into the delivery region II.

Attached to the bearing plate 10 are a housing 60 for attaching the feed device 6 and a housing 72 for the setting die 7. The housing 60 for attaching the feed device 6 has a channel section 62 which opens approximately tangentially into the receiving region of the apparatus 1 for positioning the connecting elements 2. The connecting elements 2 are conveyed through the channel section 62 with the aid of compressed air. The connecting elements 2 are positioned in the receiving region in the exemplary embodiment illustrated such that the shank extends substantially vertically and the head is arranged above the shank.

In the exemplary embodiment illustrated, the setting die 7 is displaceable in a vertical direction counter to the force of a restoring spring 74 by means of a drive (not illustrated). Provided in the axial extension of the setting die 7 is the guide element 70, which guides the movement of the setting die 7. For setting, in particular for pressing in a connecting element, the setting die 7 is movable along the guide element 70 in the direction of a component or assembly. In other configurations, no guide element is provided, wherein the setting die 7 is guided by its housing 72.

The advancing device 3 comprises, as described, a slider 30, wherein the slider 30 is mechanically coupled to a pneumatic cylinder 34 which forms a drive.

The slider 30 is driven such that its free end is moved in the direction of the delivery region II (cf. FIGS. 2 to 6). As soon as a connecting element 2 is positioned in the receiving region I (cf. FIGS. 2 to 6), said connecting element 2 is transferred into the delivery region II, as described above. The advancing device 3 is in this case preferably designed such that a maximum adjusting movement of the slider in the direction of the delivery region II is greater during an idle stroke, i.e. without a connecting element 2 being carried along, than during a positioning stroke of a connecting element 2. In one configuration, provision is made, to this end, for the connecting element 2 to be moved in an end position against an end stop during a positioning stroke, with the result that the further movement of the slider 30 is prevented. A sensor device can be used to sense whether the end position has been crossed during the movement of the slider 30. As soon as the sensor device senses crossing of the end position, an idle stroke is detected and the apparatus 1 is driven to set a connecting element once again and/or an error message is output.

By contrast, as soon as the sensor device has sensed that a connecting element 2 has been transferred into the delivery region II, the slider 30 can be pulled back and the setting die 7 can be driven to set the connecting element 2. For delivering the connecting element 2 to the setting die 7, in one configuration, the setting die 7 has clamps at its front end, which retain the connecting element 2 on the setting die 7.

The orientation, illustrated in FIGS. 1 to 7, of the apparatus 1 is merely by way of example and, depending on the requirement, other orientations are conceivable, wherein the levers 40 of the blocking device 4 are arranged parallel to the shank of the connecting elements 2 and the connecting element 2 is displaced along a plane perpendicular to the shank.

FIG. 8 shows an apparatus 1 similar to FIGS. 1 to 6 in a cross-sectional plan view during the receiving of a connecting element 2 in a receiving region I. The apparatus 1 according to FIG. 8 corresponds substantially to the apparatus 1 according to FIGS. 1 to 6 and unitary reference signs are used for identical components. A detailed description of components that have already been described will not be given again. In contrast to the FIGS. 1 to 6, the grooves 32 have run-in slopes 36 which allow the protrusions 44 to be guided out of the guide grooves 32 when the slider 30 is pulled back out of a position illustrated in FIG. 6 into the position illustrated in FIG. 8. As a result, it is possible to dispense with spring elements 45. In one modification, spring elements or other force elements, which force the levers 40 into the blocking position, are provided anyway.

1. An apparatus for positioning connecting elements, having
an advancing device and
a blocking device, which has at least one lever that is pivotable between a blocking position and a releasing position,
wherein a connecting element is transferable by means of the advancing device from a receiving region into a delivery region for a joining device, wherein the at least one lever is pivotable between a blocking position and a releasing position, and wherein the at least one lever prevents any movement of the connecting element from the receiving region into the delivery region in the blocking position,
further wherein at least one end stop that is adjustable relative to the at least one lever is provided, wherein, by means of the at least one end stop, any movement of the at least one lever from the blocking position into the releasing position is preventable, wherein the at least one lever is designed as a two-sided lever having a first arm and a second arm, and wherein a first arm of the at least one lever interacts with the at least one end stop to prevent any movement of the at least one lever from the blocking position into the releasing position, and a second arm of the at least one lever acts, in the blocking position, as a retaining jaw for the connecting element.

2. The apparatus as claimed in claim 1, wherein the blocking device has two two-sided levers that are pivotable in opposite directions, wherein the first arms of the levers interact with the end stop to prevent any movement of the levers from the blocking position into the releasing position, and the second arms of the levers act as retaining jaws for the connecting element.

3. The apparatus as claimed in claim 1, wherein the at least one lever is assigned a force element, in particular a spring element, which forces the lever into the blocking position.

4. The apparatus as claimed in claim 1, wherein the connecting element is displaceable into the delivery region along the second arm of the at least one lever by means of the advancing device.

5. The apparatus as claimed in claim 1, wherein the advancing device (3) comprises a slider (30) that is displaceable linearly relative to the at least one lever (40), wherein a first portion of the slider (30) acts as an end stop.

6. The apparatus as claimed in claim 5, wherein the slider has a second portion that is spaced apart from the first portion in a longitudinal direction, wherein the second portion has a design such as to enable the at least one lever to pivot into the releasing position after an unlocking position has been crossed.

7. The apparatus as claimed in claim 6, wherein the first arm of the lever or levers has a protrusion that projects into the adjustment travel of the slider and interacts with the end stop, wherein, preferably, a wall, facing the protrusion, of the slider has a groove in the second portion.

8. The apparatus as claimed in claim 1, wherein a maximum adjusting movement of the advancing device in the direction of the delivery region is greater during an idle stroke than during a positioning stroke of a connecting element.

9. An apparatus for setting connecting elements, comprising
a feed device for feeding connecting elements individually to a receiving region, having a setting die for setting a connecting element positioned in a delivery region, and
an advancing device and a blocking device, by means of which a connecting element is transferable from the receiving region into the delivery region.

10. A method for positioning connecting elements, comprising
transferring a connecting element (2) by means of an advancing device from a receiving region into a delivery region for a joining device,
wherein a movement of the connecting element from the receiving region into the delivery region is prevented by means of at least one lever, arranged in a blocking position, of a blocking device, and
wherein the at least one lever of the blocking device is transferred into a releasing position in order for the connecting element to move into the delivery region, characterized in that, when the connecting element is received in the receiving region, any movement of the at least one lever from the blocking position into the releasing position is prevented by means of an end stop,
wherein the at least one lever is designed as a two-sided lever having a first arm and a second arm, wherein a first arm of the at least one lever interacts with the end stop when the connecting element is received in the receiving region, such that any movement of the lever from the blocking position into the releasing position is prevented, and wherein the movement of the connecting element from the receiving region into the delivery region is prevented by means of a second arm of the at least one two-sided lever, arranged in the blocking position, of the blocking device.
